(19) United States
(12) Patent Application Publication
(10) Pub. No.: US 2012/0129695 A1
(43) Pub. Date: May 24, 2012

(54) METHOD OF PRODUCING PLANT BIOSTIMULANT

(75) Inventors: Shinya TACHIBANA, Eddyville, IA (US); Paul SUMMER, Eddyville, IA (US); Jessica EWING, Eddyville, IA (US); Tetsuya MIWA, Kanagawa (JP); Daisuke KITAZAWA, Kanagawa (JP)

(73) Assignee: AJINOMOTO NORTH AMERICA, INC, Fort Lee, NJ (US)

(21) Appl. No.: 13/298,996

(22) Filed: Nov. 17, 2011

Related U.S. Application Data
(60) Provisional application No. 61/415,146, filed on Nov. 18, 2010.

(51) Int. Cl. A01N 63/02; A01P 21/00; A23L 1/217; A23L 1/06; A23L 1/164; C14B 1/00; A21D 13/08; A23L 1/10; A23K 1/18; A23C 19/00; A23C 9/123; A23G 9/04; A01G 1/00; A21D 13/00

(52) U.S. Cl. 504/117; 47/58.1 R; 119/14.02; 452/52; 426/465; 426/496; 426/443; 426/2; 426/36; 426/34; 69/21

(57) ABSTRACT

A method of producing a plant biostimulant includes hydrolyzing bacterial cells to obtain a hydrolysate and formulating the hydrolysate as a plant biostimulant for foliar application or application as a soil adjuvant.

### CROSS REFERENCES TO RELATED APPLICATIONS

This application claims priority to U.S. Provisional Patent Application No. 61/415,146, filed on Nov. 18, 2010, which is incorporated herein by reference in its entirety.

### BACKGROUND OF THE INVENTION

1. Field of the Invention

The present invention is directed to methods of producing plant biostimulants and the biostimulants thereby produced. The present invention also relates to methods of growing plants by applying such plant biostimulant. The present invention further relates to process for preparing products from such plants, raising livestock by feeding such plants to livestock, and producing products from such livestock.

2. Discussion of the Background

Plant biostimulants are components other than fertilizers that affect plant growth and/or metabolism upon foliar application or when added to soil. Plant biostimulants generally fall within one of three categories: hormone-containing products, amino acid-containing products and humic acid-containing products. Consistent with the foregoing, exemplary plant biostimulants include compositions based on seaweed extract, humic acid, amino acids, salicylic acid, bio-solids, hydrolyzed proteins, silicate, and/or synthetic compounds. Plant biostimulants are used to treat crops in a commercial setting in view of their ability to, for example, increase growth rates, decrease pest plant growth, increase stress tolerance, increase photosynthetic rate, and increase disease tolerance. Plant biostimulants are generally believed to operate by up-regulating or down-regulating plant hormones.

Despite the numerous fertilizers and plant biostimulants commercially available, there continues to be a demand for improved products capable of serving a variety of needs. In particular, there is a need for plant biostimulants having the effect of increasing the tolerance of plants within the turfgrass, horticulture and agriculture industries to stressors. Exemplary stressors include heat, drought, wear, excess moisture, salinity and others. There is also a need to increase the reproductive rate of turfgrass and other plants of economic interest. There is further a need for plant biostimulants that are effective when applied on a less frequent basis than commercial products that are present available. Still further, there is a need for plant biostimulants that offer a reduced risk of plant injury if over-applications occur. There is also a need to increase the nutrient use efficiency of food crops to reduce nutrient leaching into the environment.

### SUMMARY OF THE INVENTION

Accordingly, it is one object of the present invention to provide novel methods of producing plant biostimulants.

It is another object of the present invention to provide novel biostimulants produced by such a process.

It is another object of the present invention to provide novel methods of growing plants by applying such plant biostimulant.

It is another object of the present invention to provide novel processes for preparing products from such plants.

It is another object of the present invention to provide novel methods of raising livestock by feeding such plants to livestock.

It is another object of the present invention to provide novel methods of producing products from such livestock.

These and other objects, which will become apparent during the following detailed description, have been achieved by the inventors' discovery that a process involving

hydrolyzing bacterial cells to obtain a hydrolysate; and

formulating the hydrolysate as the plant biostimulant for foliar application or application as a soil adjuvant

provides an effective biostimulant for plants.

Thus, the present invention provides:

1. A method of producing a plant biostimulant, comprising:

hydrolyzing bacterial cells to obtain a hydrolysate; and

formulating the hydrolysate as the plant biostimulant for foliar application or application as a soil adjuvant.

2. A method according to 1, wherein hydrolyzing bacterial cells comprises hydrolyzing a cell cream having a solids content of from about 1 to about 30 weight percent.

3. A method according to 1, wherein hydrolyzing bacterial cells comprises hydrolyzing a cell cream having a solids content of from about 5 to about 25 weight percent.

4. A method according to 1, wherein hydrolyzing bacterial cells comprises hydrolyzing a cell cream having a solids content of from about 10 to about 20 weight percent.

5. A method according to 1, wherein hydrolyzing bacterial cells comprises hydrolyzing a cell cream having a nitrogen content of from about 0.12 to about 4 weight percent.

6. A method according to 1, wherein hydrolyzing bacterial cells comprises hydrolyzing a cell cream having a nitrogen content of from about 0.63 to about 3.2 weight percent.

7. A method according to 1, wherein hydrolyzing bacterial cells comprises hydrolyzing a cell cream having a nitrogen content of from about 1.2 to about 2.4 weight percent.

8. A method according to 1, wherein hydrolyzing bacterial cells comprises hydrolyzing with at least one enzyme that is capable of hydrolyzing bacterial proteins into at least one of free amino acids and short peptides.

9. A method according to 1, wherein hydrolyzing bacterial cells comprises performing acid hydrolysis.

10. A method according to 9, wherein performing acid hydrolysis comprises adjusting a pH of a composition comprising the bacterial cells to a pH of from about 0.5 to about 5.

11. A method according to 9, wherein performing acid hydrolysis comprises adjusting a pH of a composition comprising the bacterial cells to a pH of from about 1 to about 5.

12. A method according to 9, wherein performing acid hydrolysis comprises adjusting a pH of a composition comprising the bacterial cells to a pH of from about 3.5 to pH about 4.5.

13. A method according to 9, wherein performing acid hydrolysis comprises adjusting a pH of a composition comprising the bacterial cells with sulfuric acid.

14. A method according to 9, wherein performing acid hydrolysis comprises adjusting a pH of a composition comprising the bacterial cells with at least one agent selected from the group consisting of hydrochloric acid, phosphoric acid, carbonic acid, boric acid, acetic acid, propionic acid, and citric acid.

15. A method according to 9, wherein performing acid hydrolysis comprises adjusting a pH of a composition comprising the bacterial cells and heating the pH-adjusted composition at a temperature of from 30° C. to 200° C.

16. A method according to 9, wherein performing acid hydrolysis comprises adjusting a pH of a composition comprising the bacterial cells and heating the pH-adjusted composition at a temperature of from 50° C. to 150° C.

17. A method according to 9, wherein performing acid hydrolysis comprises adjusting a pH of a composition comprising the bacterial cells and heating the pH-adjusted composition at a temperature of from 100° C. to 130° C.

18. A method according to 9, wherein performing acid hydrolysis comprises adjusting a pH of a composition comprising the bacterial cells and heating the pH-adjusted composition under pressure.

19. A method according to 1, wherein hydrolyzing bacterial cells comprises performing alkali hydrolysis.

20. A method according to 19, wherein performing alkali hydrolysis comprises adjusting a pH of a composition comprising the bacterial cells to a pH of from about 8 to about 14.

21. A method according to 19, wherein performing alkali hydrolysis comprises adjusting a pH of a composition comprising the bacterial cells to a pH of from about 9 to about 12.

22. A method according to 19, wherein performing alkali hydrolysis comprises adjusting a pH of a composition comprising the bacterial cells to a pH of from about 9.5 to pH about 11.5.

23. A method according to 19, wherein performing alkali hydrolysis comprises adjusting a pH of a composition comprising the bacterial cells with potassium hydroxide.

24. A method according to 19, wherein performing alkali hydrolysis comprises adjusting a pH of a composition comprising the bacterial cells with at least one agent selected from the group consisting of sodium hydroxide, calcium oxide, magnesium oxide, and ammonia.

25. A method according to 19, wherein performing alkali hydrolysis comprises adjusting a pH of a composition comprising the bacterial cells and heating the pH-adjusted composition at a temperature of from 30° C. to 200° C.

26. A method according to 19, wherein performing alkali hydrolysis comprises adjusting a pH of a composition comprising the bacterial cells and heating the pH-adjusted composition at a temperature of from 50° C. to 150° C.

27. A method according to 19, wherein performing alkali hydrolysis comprises adjusting a pH of a composition comprising the bacterial cells and heating the pH-adjusted composition at a temperature of from 100° C. to 130° C.

28. A method according to 19, wherein performing alkali hydrolysis comprises adjusting a pH of a composition comprising the bacterial cells and heating the pH-adjusted composition under pressure.

29. A method according to 1, wherein hydrolyzing bacterial cells comprises performing enzymatic hydrolysis.

30. A method according to 29, wherein performing enzymatic hydrolysis comprises hydrolyzing with a purified enzyme.

31. A method according to 29, wherein performing enzymatic hydrolysis comprises hydrolyzing with a mixture of an enzyme and a medium in which the enzyme was prepared.

32. A method according to 29, wherein performing enzymatic hydrolysis comprises hydrolyzing with an enzyme of plant origin.

33. A method according to 29, wherein performing enzymatic hydrolysis comprises hydrolyzing with an enzyme of animal origin.

34. A method according to 29, wherein performing enzymatic hydrolysis comprises hydrolyzing with an enzyme of bacterial origin.

35. A method according to 29, wherein performing enzymatic hydrolysis comprises hydrolyzing with an enzyme of fungal origin.

36. A method according to 29, wherein performing enzymatic hydrolysis comprises hydrolyzing with a mixture of one or more enzymes of plant origin, enzymes of animal origin, enzymes of bacterial origin and enzymes of fungal origin.

37. A method according to 29, wherein performing enzymatic hydrolysis comprises hydrolyzing with at least one member selected from the group consisting of proteases, lipases and amylases.

38. A method according to 29, wherein performing enzymatic hydrolysis comprises hydrolyzing with at least one member selected from the group consisting of pancreatin, papain, bromelain, bacterial protease, fungal protease, trypsin, chymotrypsin, pepsin and rennin.

39. A method according to 29, wherein performing enzymatic hydrolysis comprises combining an enzyme and the bacterial cells in a weight ratio of from about 0.1 to about 10 g of enzyme per 100 g of nitrogen content of bacterial cells.

40. A method of claim 29, wherein performing enzymatic hydrolysis comprises combining an enzyme and the bacterial cells in a weight ratio of from about 0.5 to about 7.5 g of enzyme per 100 g of nitrogen content of bacterial cells.

41. A method according to 29, wherein performing enzymatic hydrolysis comprises combining an enzyme and the bacterial cells in a weight ratio of from about 1.0 to about 5.0 g of enzyme per 100 g of nitrogen content of bacterial cells.

42. A method according to 29, wherein performing enzymatic hydrolysis comprises combining an enzyme and the bacterial cells and agitating the combined enzyme and bacterial cells.

43. A method according to 29, wherein performing enzymatic hydrolysis comprises reacting an enzyme and the bacterial cells in the presence of a catalyst.

44. A method according to 43, wherein the catalyst comprises at least one member selected from the group consisting of iron, copper, cobalt, nickel, boron, magnesium, calcium and rare earth metals.

45. A method according to 29, wherein performing enzymatic hydrolysis comprises reacting an enzyme and the bacterial cells while electric current is applied.

46. A method according to 29, wherein performing enzymatic hydrolysis comprises treating the bacterial cells with electrical current before enzymatically hydrolyzing the bacterial cells.

47. A method according to 29, wherein performing enzymatic hydrolysis comprises treating the bacterial cells with a mild acid before enzymatically hydrolyzing the bacterial cells.

48. A method according to 29, wherein performing enzymatic hydrolysis comprises treating the bacterial cells with a mild alkali before enzymatically hydrolyzing the bacterial cells.

49. A method according to 29, wherein performing enzymatic hydrolysis comprises treating the bacterial cells with ultrasonic vibration before enzymatically hydrolyzing the bacterial cells.

50. A method according to 29, wherein performing enzymatic hydrolysis comprises treating the bacterial cells with supercritical water before enzymatically hydrolyzing the bacterial cells.

51. A method according to 29, wherein performing enzymatic hydrolysis comprises treating the bacterial cells with supercritical carbon dioxide before enzymatically hydrolyzing the bacterial cells.

52. A method according to 1, wherein formulating the hydrolysate comprises formulating for foliar application.

53. A method according to 1, wherein formulating the hydrolysate comprises formulating for application as a soil adjuvant.

54. A method according to 1, wherein formulating the hydrolysate comprises formulating without chelating the hydrolysate and without separating amino acids from the hydrolysate.

55. A method according to 1, wherein formulating the hydrolysate comprises collecting both liquid and solid fractions of the hydrolysate.

56. A method according to 1, wherein formulating the hydrolysate comprises collecting separating liquid and solid fractions of the hydrolysate and retaining the liquid fraction as the plant biostimulant.

57. A method according to 1, wherein formulating the hydrolysate comprises collecting separating liquid and solid fractions of the hydrolysate and retaining the solid fraction as the plant biostimulant.

58. A method according to 57, further comprising granulating the solid fraction.

59. A method according to 58, wherein granulating the solid fraction comprises granulating using an apparatus selected from the group consisting of feed pelletizers, pin mixers, disc pelletizers, drum pelletizers, and compaction granulators.

60. A method according to 58, wherein granulating the solid fraction comprises granulating to obtain granules having a size of from about 0.25 mm to about 5 mm.

61. A method according to 58, wherein granulating the solid fraction comprises granulating to obtain granules having a size of from about 0.35 mm to about 3.5 mm.

62. A method according to 58, wherein granulating the solid fraction comprises granulating to obtain granules having a size of from about 0.5 mm to about 2 mm.

63. A method according to 57, further comprising dispersing or dissolving the solid fraction in an aqueous medium.

64. A method o according to 1, wherein the plant biostimulant has a total nitrogen content of from 5 to 15 wt % on a dry matter basis.

65. A method according to 1, wherein the plant biostimulant has a total nitrogen content of from about 1 to about 12% by weight on a dry matter basis.

66. A method according to 1, wherein the plant biostimulant has a total nitrogen content of from about 3.5 to about 12% by weight on a dry matter basis.

67. A method according to 1, wherein a total solids content of the plant biostimulant is from 2 to 100 wt %.

68. A method according to 1, wherein a total solids content of the plant biostimulant is from about 5 to about 95% by weight.

69. A method according to 1, wherein a total solids content of the plant biostimulant is from 25 to about 90% by weight.

70. A method according to 1, wherein a pH of the plant biostimulant is from 2 to 10.

71. A method according to 1, wherein a pH of the plant biostimulant is from 3 to 7.

72. A method according to 1, wherein a pH of the plant biostimulant is from 4 to 6.

73. A method according to 1, further comprising adding at least one of an amino acid fermentation liquid and microbial cells to the plant biostimulant.

74. A method according to 1, further comprising adding at least one preservative to the plant biostimulant.

75. A method according to 74, wherein the at least one preservative comprises at least one member selected from the group consisting of citric acid, benzoic acid, propylene glycol, propionic acid, sorbic acid, zinc sulfate, iron sulfate, copper sulfate, and silver chloride.

76. A method according to 1, further comprising adding a fertilizer or plant macro-nutrient to the plant biostimulant.

77. A method according to 76, wherein the fertilizer or plant macro-nutrient comprises at least one member selected from the group consisting of nitrogen, potassium, phosphorous, iron, copper, zinc, boron, mangansese, calcium, molybdenum, and magnesium.

78. A method according to 1, further comprising adding at least one member selected from the group consisting of herbicides, pesticides and fungicides, to the plant biostimulant.

79. A method according to 1, further comprising adding at least one member selected from the group consisting of thiophanate methyl, chlorothalonil, captan, piperalin, fenarimol, metalaxyl, triforine, ethoxy thialdiazole, pyretin, algicide, oryzalin, aldxylarypolyethoxyethanol, glyphosate, and naphthalene, to the plant biostimulant.

80. A method according to 1, wherein the bacterial cells are gram negative.

81. A method according to 1, wherein the bacterial cells are obtained as a by-product of an industrial process that generates bacterial mass.

82. A method according to 81, wherein the industrial process is selected from the group consisting of ethanol production, organic acid production, and waste-water treatment.

83. A method according to 1, wherein the bacterial cells are obtained as a by-product of amino acid production.

84. A method according to 83, wherein the bacterial cells are provided in spent media from production of at least one amino acid selected from the group consisting of lysine, threonine, tryptophan and glutamic acid.

85. A plant biostimulant, obtained by a process according to 1.

86. A process for treating a crop, comprising applying a plant biostimulant according to 85 to a crop.

87. A process according to 86, wherein the crop comprises turfgrass.

88. A process according to 86, wherein the plant biostimulant is applied in an amount of from about 0.001 to about 3.0 lbs. of nitrogen per 1,000 square feet.

89. A process according to 86, wherein the plant biostimulant is applied in an amount of from about 0.05 to about 1.5 lbs. of nitrogen per 1,000 square feet.

90. A process according to 86, wherein the plant biostimulant is applied in an amount of from about 0.1 to about 1.0 lbs. of nitrogen per 1,000 square feet.

91. A process according to 86, wherein applying the plant biostimulant to the crop comprises applying the plant biostimulant and a fertilizer to the crop.

92. A process according to 86, wherein applying the plant biostimulant to the crop comprises applying the plant biostimulant and at least one member selected from the group consisting of herbicides, pesticides and fungicides to the crop.

93. A process of making an agricultural product, comprising:

applying a plant biostimulant of claim 85 to a crop; and

harvesting the crop to obtain the agricultural product.

94. A process according to 93, wherein the crop is a food crop.

95. A process according to 93, wherein the food crop comprises at least member selected from the group consisting of a fruit, a vegetable, and a grain.

96. A process according to 93, wherein the crop is an ornamental crop.

97. A process according to 96, wherein the ornamental crop comprises at least member selected from the group consisting of turfgrass, a tree, a shrub, and a flower.

98. A process of making a consumer product, comprising:

applying a plant biostimulant according to 85 to a crop;

harvesting the crop to obtain an agricultural product; and

processing the agricultural product to obtain the consumer product.

99. A process according to 98, wherein the crop is a food crop.

100. A process according to 99, wherein the food crop comprises at least member selected from the group consisting of fruits, vegetables and grains.

101. A process according to 98, wherein the crop is an ornamental crop.

102. A process according to 101, wherein the ornamental crop comprises at least member selected from the group consisting of turfgrass, a tree, a shrub, and a flower.

103. A process of making an industrial product, comprising:

applying a plant biostimulant according to 85 to a crop;

harvesting the crop to obtain an agricultural product; and

processing the agricultural product to obtain the industrial product.

104. A process according to 103, wherein the crop is a food crop.

105. A process according to 104, wherein the food crop comprises at least member selected from the group consisting of a fruit, a vegetable, and a grain.

106. A process according to 103, wherein the crop is an ornamental crop.

107. A process according to 106, wherein the ornamental crop comprises at least member selected from the group consisting of turfgrass, a tree, a shrub, and a flower.

The present inventors have developed plant biostimulants that are obtained by hydrolyzing microbial cells (e.g., microbial cells present in an amino acid fermentation liquid). A plant biostimulant produced in this manner could be categorized as an amino acid-containing plant biostimulant. Plant biostimulants according to the present invention increase plants' natural resistance to stressors by increasing de-novo synthesis of stress fighting compounds such as antioxidants. Plant biostimulants according to the present invention also increase the reproductive rates of plants by, for example, increasing the number of shoots produced by turfgrass. Plant biostimulants according to the present invention may be applied to plants less frequently and/or at longer intervals while eliciting similar or superior effects in comparison with known biostimulants. Plant biostimulants according to the present invention do not show any adverse effects due to over-application to plants.

The plant biostimulants developed by the present inventors are particularly well suited for application to turfgrass. When applied to turfgrass, the plant biostimulants of the present invention have the effect of for example, increasing resistance to stress from heat, drought, wear, traffic, and/or salinity. The plant biostimulants of the present invention also have the effect of increasing shoot density in turfgrass.

Accordingly, it is an object of the present invention to provide a composition that can be used in both horticulture and agriculture as a plant biostimulant for application to grass and plants and/or as a soil adjuvant.

It is further object of the present invention to provide a relatively simple and inexpensive method for preparing the above biostimulant.

It is a further object of the present invention to provide a process for treating a crop, comprising applying a plant biostimulant according to the present invention to a crop.

In various exemplary embodiments, methods of producing plant biostimulants according to the present invention include hydrolyzing bacterial cells to obtain a hydrolysate, and formulating the hydrolysate as the plant biostimulant for foliar application or application as a soil adjuvant.

In various exemplary embodiments, plant biostimulants according to the present invention include plant biostimulants obtained by the methods described herein.

In various exemplary embodiments, processes for treating crops according to the present invention include applying plant biostimulants as described herein to crops.

In various exemplary embodiments, processes for making agricultural products according to the present invention include applying plant biostimulants as described herein to crops, and harvesting the crops to obtain the agricultural products.

In various exemplary embodiments, processes of making consumer products according to the present invention include applying plant biostimulants as described herein to crops, harvesting the crops to obtain agricultural products, and processing the agricultural products to obtain the consumer products.

In various exemplary embodiments, processes of making industrial products according to the present invention include applying plant biostimulants as described herein to crops, harvesting the crops to obtain agricultural products, and processing the agricultural products to obtain the industrial products.

### DETAILED DESCRIPTION OF THE PREFERRED EMBODIMENTS

As indicated above, in various exemplary embodiments, the present invention includes methods of producing plant biostimulants, including hydrolyzing bacterial cells to obtain a hydrolysate, and formulating the hydrolysate as a plant biostimulant for foliar application or application as a soil adjuvant. The present invention is also directed to plant biostimulants obtained by the methods described herein.

In various exemplary embodiments, microbial cells are hydrolyzed. Microbial cells may be processed by hydrolysis to yield shorter chain compounds with much reduced viscosity compared with intact cells or partially lysed cells. While its is possible to use other cells, microbial cells (preferably prokaryotic cells and more preferably bacterial or eubactaterial cells) are employed to prepare plant biostimulants according to the present invention. Amine-containing compounds may be obtained by hydrolyzing plant or animal cells. However, exemplary methods according to the present invention in which bacterial cells are hydrolyzed also yield bio-active compounds such as peptidoglycans and lypopolysaccharides that may act as plant biostimulants.

Various sources of bacterial cells are feasibly employed in the methods according to the present invention. For example, bacterial cells can be obtained from any industrial process that generates bacterial mass such as ethanol production, organic acid production, and waste-water treatment. In exemplary embodiments, the bacterial cells used to produce plant biostimulants are gram negative. As indicated above, a particularly preferred source of bacterial cells are bacterial cells obtained as a by-product of amino acid production. Bacterial cells may be provided in spent media from production of one or more amino acids including, but not limited to, arginine, histidine, isoleucine, leucine, lysine, methionine, phenylalanine, threonine, tryptophan, valine, glycine, serine, cysteine, tyrosine, alanine, aspartic acid, glutamic acid, proline, asparagines and glutamine. Desirably, bacterial cells are provided in spent media from production of one or more amino acids including, but not limited to, lysine, threonine, tryptophan and glutamic acid. In a particularly preferred embodiment, the bacterial cells used to produce plant biostimulants are bacterial cells present in spent media obtained from production of lysine.

In various exemplary embodiments, the bacterial cells used to produce plant biostimulants are provided in the form of a cell cream (e.g., a cell cream obtained as a by-product of lysine production). The cell cream may have a solids content of from 1 to 30 weight percent or from about 1 to about 30 weight percent. In some embodiments, the cell cream may have a solids content of from 5 to 25 weight percent or from about 5 to about 25 weight percent. In further embodiments, the cell cream may have a solids content of from 10 to 20 weight percent or from about 10 to about 20 weight percent.

In embodiments, the bacterial cells used to produce plant biostimulants are provided in the form of a cell cream having a nitrogen content of from 0.12 to 4 weight percent or from about 0.12 to about 4 weight percent. In further embodiments, the cell cream may have a nitrogen content of from 0.63 to 3.2 weight percent or from about 0.63 to about 3.2 weight percent. In still further embodiments, the cell cream may have a nitrogen content of from 1.2 to 2.4 weight percent or from about 1.2 to about 2.4 weight percent.

Hydrolysis of bacterial cells may be carried out by any known method which substantially lyses cell components into short chain or single compounds. Alternatively, a partial hydrolysis can be utilized to produce a plant biostimulant from cells by utilizing a less energy intensive and shorter hydrolysis period.

Hydrolysis of bacterial cells may be accomplished methods including acid or alkali hydrolysis and using typical heat and pressure conditions. In various exemplary embodiments, alkali hydrolysis is carried out by adjusting pH of a bacterial cell cream using potassium hydroxide to a pH of from about 8 to about 14, more preferably to a pH of from about 9 to about 12, and even more preferably to a pH of from about 9.5 to pH about 11.5. The pH of the bacterial cells may alternatively be adjusted using agents including, but not limited to sodium hydroxide, calcium oxide, magnesium oxide, and ammonia. In various exemplary embodiments, following pH adjustment, a bacterial cell cream may be heated to a temperature of from 30° C. to 200° C., more preferably to a temperature of from 50° C. to 150° C., and even more preferably to a temperature of from 100° C. to 130° C. In various exemplary embodiments, heating may be carried out for periods of from about 10 minutes to about 48 hours, more preferably for periods of from about 1 hour to about 24 hours, and even more preferably for periods of from about 2 hours to about 6 hours. Such alkali hydrolysis techniques yield a hydrolysate including solubles and cell wall debris. The hydrolysate may be applied as is, as a biostimulant, or may be separated into soluble and insoluble fractions for foliar or soil applications, respectively.

In various exemplary embodiments, acid hydrolysis is carried out by adjusting pH of a bacterial cell cream using sulfuric acid to a pH of from about 0.5 to about 5, more preferably to a pH of from about 1 to about 5, and even more preferably to a pH of from about 3.5 to pH about 4.5. The pH of the bacterial cells may alternatively be adjusted using agents including, but not limited to hydrochloric acid, phosphoric acid, carbonic acid, boric acid, acetic acid, propionic acid, and citric acid. In various exemplary embodiments, following pH adjustment, a bacterial cell cream may be heated to a temperature of from 30° C. to 200° C., more preferably to a temperature of from 50° C. to 150° C., and even more preferably to a temperature of from 100° C. to 130° C. In various exemplary embodiments, heating may be carried out for periods of from about 10 minutes to about 48 hours, more preferably for periods of from about 1 hour to about 24 hours, and even more preferably for periods of from about 2 hours to about 6 hours. Such acid hydrolysis techniques yield a hydrolysate including solubles and cell wall debris. The hydrolysate may be applied as is, as a biostimulant, or may be separated into soluble and insoluble fractions for foliar or soil applications, respectively.

Alternatively, enzymatic hydrolysis may be employed. Enzymatic hydrolysis is possible because the employed microbial cells are amenable to enzymatic hydrolysis. By employing such cells it is possible to obtain plant biostimulants using alternatives to strong acid or base hydrolysis.

In various exemplary embodiments of the methods of the present invention, enzymatic hydrolysis of bacterial cells may be carried out using any suitable enzyme or enzymatic composition. The enzyme source may be any enzyme or mixture of enzymes that is capable of hydrolyzing proteins of the bacterial cells into free amino acids and/or short peptides. The bacterial cells may be hydrolyzed with a purified enzyme. The bacterial cells may also be hydrolyzed with a mixture of an enzyme and a medium in which the enzyme was prepared. In embodiments, the bacterial cells may be hydrolyzed with an enzyme of plant origin. In other embodiments, the bacterial cells may be hydrolyzed with an enzyme of animal origin. In further embodiments, the bacterial cells may be hydrolyzed with an enzyme of bacterial origin. In still embodiments, the bacterial cells may be hydrolyzed with an enzyme of fungal origin. In alternative embodiments, the bacterial cells may be hydrolyzed with a mixture of one or more enzymes of plant origin, enzymes of animal origin, enzymes of bacterial origin, and enzymes of fungal origin. In exemplary embodiments, bacterial cells may be hydrolyzed with one or more of proteases, lipases and amylases. In some such embodiments, bacterial cells may be hydrolyzed with one or more of papain, bromelain, bacterial protease, fungal protease, trypsin, chymotrypsin, pepsin and rennin. In a particularly preferred embodiment, bacterial cells are hydrolyzed with pancreatin. As would be well-understood by one of ordinary skill in the art, pancreatin includes a mixture of digestive enzymes, proteases, lipases and amylases.

As discussed above, in various exemplary embodiments of the present invention, methods of producing plant biostimulants include producing plant biostimulants by enzymatically hydrolyzing bacterial cells obtained as a by-product of amino acid production. Enzymatically hydrolyzing bacterial cells may include combining an enzyme and bacterial cells in any suitable amount under any suitable conditions. Generally, quantities of reactants, reaction conditions, and sequences of reaction steps are selected to achieve ideal enzyme activity. In embodiments, enzymatically hydrolyzing bacterial cells may include combining an enzyme and bacterial cells in a weight ratio of from 0.1 to 10 g of enzyme per 100 g of nitrogen content of bacterial cells or from about 0.1 to about 10 g of enzyme per 100 g of nitrogen content of bacterial cells. In further embodiments, enzymatically hydrolyzing bacterial cells may include combining an enzyme and bacterial cells or from 0.5 to 7.5 g of enzyme per 100 g of nitrogen content of bacterial cells or from about 0.5 to about 7.5 g of enzyme per 100 g of nitrogen content of bacterial cells. In still further embodiments, enzymatically hydrolyzing bacterial cells may include combining an enzyme and bacterial cells in a weight ratio of from 1.0 to 5.0 g of enzyme per 100 g of nitrogen content of bacterial cells or from about 1.0 to about 5.0 g of enzyme per 100 g of nitrogen content of bacterial cells.

As indicated above, hydrolysis may be carried out under any suitable conditions. In various exemplary embodiments, hydrolysis may be carried out at a pH of from 2 to 10 or a pH of from about 2 to about 10. In further embodiments, hydrolysis may be carried out at a pH of from 4 to 8 or a pH of from about 4 to about 8. In still further embodiments, hydrolysis may be carried out at a pH of from 5.5 to 7 or a pH of from about 5.5 to about 7. It should be appreciated that each type of enzyme hydrolyzes at it's own optimum pH optimum, and the optimum pH may vary depending on the rate and extent of hydrolysis desired. In various exemplary embodiments, hydrolysis may be carried out at a temperature of from 15.5° C. to 55° C. or a temperature of from about 15.5° C. to about 55° C. In further embodiments, hydrolysis may be carried out at a temperature of from 20° C. to 45° C. or a temperature of from about 20° C. to about 45° C. In still further embodiments, hydrolysis may be carried out at a temperature of from 27° C. to 39° C. or a temperature of from about 27° C. to about 39° C. In various exemplary embodiments, hydrolysis may be carried out for a period of from 2 hours to 120 hours or a period of from about 2 hours to about 120 hours. In further embodiments, hydrolysis may be carried out for a period of from 12 hours to 96 hours or a period of from about 12 hours to about 96 hours. In still further embodiments, hydrolysis may be carried out for a period of from 24 hours to 48 hours or a period of from about 24 hours to about 48 hours.

In various exemplary embodiments, any suitable method may be employed to improve the efficiency of the enzymatic hydrolysis of the bacterial cells. For example, enzymatically hydrolyzing bacterial cells may include combining an enzyme and the bacterial cells and agitating the combined enzyme and bacterial cells. Agitation may be performed by any suitable method. In exemplary embodiments, enzymatically hydrolyzing bacterial cells may include reacting an enzyme and the bacterial cells in the presence of a catalyst. Any catalyst that improves the efficiency of the enzyme or enzymes may be employed. Catalysts that may be employed include heterogeneous catalysts, homogeneous catalysts and/or electrocatalysts. In some such embodiments, the catalyst may include iron. Other exemplary catalysts include copper, cobalt, nickel, boron, magnesium, calcium and rare earth metals, such as lanthium. Alternatively, enzymatically hydrolyzing bacterial cells may include reacting an enzyme and the bacterial cells while electric current is applied.

Various exemplary embodiments of the methods of present invention may further include a pretreatment before enzymatically hydrolyzing bacterial cells. The efficiency of bacterial protein hydrolysis using enzymes can be improved by using various pre-treatment methods. Such pretreatment methods are believed to degrade the structure of the bacterial cells and, thus, increase the rate and extent of hydrolysis by an enzyme. By increasing the efficiency of bacterial protein hydrolysis, it is possible to perform hydrolysis using less enzyme or perform hydrolysis in less time that would ordinarily be required with a given amount of enzyme. It is particularly desirable to perform hydrolysis using less enzyme, as a reduction in the amount of enzyme used can substantially reduce production costs.

In embodiments, the bacterial cells are treated with electrical current before enzymatically hydrolyzing the cells. In further embodiments, the bacterial cells are treated with a mild acid before enzymatically hydrolyzing the cells. The bacterial cells may also be treated with a mild alkali before enzymatically hydrolyzing the cells. The bacterial cells may be treated with ultrasonic vibration before enzymatically hydrolyzing the cells. The bacterial cells may be treated with supercritical water before enzymatically hydrolyzing the cells. Further, the bacterial cells may be treated with supercritical carbon dioxide before enzymatically hydrolyzing the bacterial cells.

Electrical current may be applied to bacterial cells by any suitable means and under any suitable conditions. Exemplary means and conditions for applying electrical current are described, for example, in Tokuda, et al., “Effects of electrical pre-treatment on the hydrolysis of agricultural wastes,” J. Brewing Soc. Jap., 101(10): 769-775 (2006), which is incorporated herein by reference in its entirety. In various exemplary embodiments, electrical current is applied in an amount of from 2 to 120 V or from about 2 to about 120 V. In further embodiments, electrical current is applied in an amount of from 5 to 80 V or from about 5 to about 80 V. In still further embodiments, electrical current is applied in an amount of from 10 to 40 V or from about 10 to about 40 V. In various exemplary embodiments, electrical current is applied for a period of from 1 to 60 minutes or from about 1 to about 60 minutes. In further embodiments, electrical current is applied for a period of from 2 to 20 minutes or from about 2 to about 20 minutes. In still further embodiments, electrical current is applied for a period of from 4 to 10 minutes or from about 4 to about 10 minutes.

In various exemplary embodiments, a mild acidic pretreatment is carried about by adjusting a pH of the bacterial cells. In embodiments, pH is adjusted using an acid such as hydrochloric acid or sulfuric acid. In embodiments, the pH is adjusted to from 3 to 5 or from about 3 to about 5. In further embodiments, the pH is adjusted to from 3.5 to 4.5 or from about 3.5 to about 4.5. In embodiments, mild acidic pretreatment may be carried out at a temperature of from 100° C. to 130° C. or from about 100° C. to about 130° C. In various exemplary embodiments, mild acidic pretreatment may be carried out for a period of from 0.25 hours to 10 hours or from about 0.25 hours to about 10 hours. In further embodiments, mild acidic pretreatment may be carried out for a period of from 0.5 hours to 5 hours or from about 0.5 hours to about 5 hours. In still further embodiments, mild acidic pretreatment may be carried out for a period of from 1 hour to 3 hours or from about 1 hour to about 3 hours.

In various exemplary embodiments, a mild basic pretreatment is carried about by adjusting a pH of the bacterial cells. In embodiments, pH is adjusted using a base such as sodium hydroxide, potassium hydroxide or ammonia. In embodiments, the pH is adjusted to from 9 to 12 or from about 9 to about 12. In further embodiments, the pH is adjusted to from 10 to 11 or from about 10 to about 11. In embodiments, mild basic pretreatment may be carried out at a temperature of from 100° C. to 130° C. or from about 100° C. to about 130° C. In various exemplary embodiments, mild basic pretreatment may be carried out for a period of from 0.25 hours to 10 hours or from about 0.25 hours to about 10 hours. In further embodiments, mild basic pretreatment may be carried out for a period of from 0.5 hours to 5 hours or from about 0.5 hours to about 5 hours. In still further embodiments, mild basic pretreatment may be carried out for a period of from 1 hour to 3 hours or from about 1 hour to about 3 hours.

In various exemplary embodiments of the methods according to the present invention, the hydrolysate obtained by the methods described herein is formulated for foliar application (e.g., as a liquid product) or for application as a soil adjuvant (e.g., as a dry product). In various exemplary embodiments, formulating the hydrolysate includes formulating without carrying out a process in which one or more constituents of the hydrolysate is subjected to chelation. In various exemplary embodiments, formulating the hydrolysate includes formulating without carrying out a process by which one or more amino acids are separated from the hydrolysate.

In various exemplary embodiments of the methods according to the present invention, formulating the hydrolysate includes collecting both liquid and solid fractions of the hydrolysate. For example, formulating the hydrolysate may include simply collecting the hydrolysate. That is, it may be desirable to simply apply the hydrolysate to crops as a plant biostimulant without removing either the liquid or solid fraction of the hydrolysate.

In various exemplary embodiments of the methods according to the present invention, formulating the hydrolysate includes collecting only one of the liquid and solid fractions of the hydrolysate. For example, formulating the hydrolysate may include separating the hydrolysate into solid and liquid fractions and retaining only one of such fractions. In such case, the liquid fraction may be applied to crops as a plant biostimulant. Alternatively, the solid fraction may be applied to crops as a plant biostimulant, either in solid form or after being re-dissolved in a suitable solvent, such as an aqueous medium. Formulating the hydrolysate may also include collecting all of one of the solid fraction and the liquid fraction of the hydrolysate and only a portion of the other fraction. Alternatively, formulating the hydrolysate may include collecting only a portion of each of the solid fraction and the liquid fraction of the hydrolysate.

In various exemplary embodiments, formulating the hydrolysate may include collecting a dry product by separation and/or by driving off a solvent, and then granulating the dried product. In various exemplary embodiments, granulation may be carried out using apparatus including, but not limited to, feed pelletizers, pin mixers, disc pelletizers, drum pelletizers, and compaction granulators. In various exemplary embodiments, granulation may be carried out to obtain granules having a size of from about 0.25 mm to about 5 mm, more preferably from about 0.35 mm to about 3.5 mm, and even more preferably from about 0.5 mm to about 2 mm. The granulated product may be applied to crops as-is, or may be reconstituted as a liquid by adding a solvent and then applied to crops.

In various exemplary embodiments, the methods of the present invention yield plant biostimulants having a total nitrogen content of from 0.5 to 15% by weight, more preferably from about 1 to about 12% by weight, and even more preferably from about 3.5 to about 12% by weight, on dry matter basis.

In various exemplary embodiments, the methods of the present invention yield plant biostimulants having a total solids content of the plant biostimulant is from 2 to 100% by weight, more preferably from about 5 to about 95% by weight, and even more preferably from 25 to about 90% by weight.

In various exemplary embodiments, the methods of the present invention yield plant biostimulants having a pH of from 2 to 10. In further embodiments, the methods of the present invention yield plant biostimulants having a pH of from 3 to 7. In still further embodiments, the methods of the present invention yield plant biostimulants having a pH of from 4 to 6.

In various exemplary embodiments, the methods of the present invention include adding additional components to the obtained plant biostimulants. Such additional components may be added during hydrolysis, during formulation and/or after the plant biostimulant is formulated. In various exemplary embodiments, the methods of the present invention include adding at least one of an amino acid fermentation liquid and microbial cells to the plant biostimulant. In various exemplary embodiments, the methods of the present invention include adding at least one preservative to the plant biostimulant. Exemplary preservatives include, but are not limited to, citric acid, benzoic acid, propylene glycol, propionic acid, sorbic acid, zinc sulfate, iron sulfate, copper sulfate, and silver chloride. In various exemplary embodiments, the methods of the present invention include adding at least one fertilizer or plant macro-nutrient to the plant biostimulant. Exemplary fertilizers and plant macro-nutrients include, but are not limited to, nitrogen, potassium, and phosphorous, and trace nutrients such as iron, copper, zinc, boron, mangansese, calcium, molybdenum, and magnesium. In various exemplary embodiments, the methods of the present invention include adding at least one herbicide, pesticide or fungicide to the plant biostimulant. Exemplary herbicides, pesticides, and fungicides include, but are not limited to, thiophanate methyl, chlorothalonil, captan, piperalin, fenarimol, metalaxyl, triforine, ethoxy thialdiazole, pyretin, algicide, oryzalin, aldxylarypolyethoxyethanol, glyphosate, and naphthalene.

The present invention is further directed to methods of applying the plant biostimulants described herein to crops. Although the crops to which the plant biostimulants of the present invention may be applied are not particularly limited, in embodiments the plant biostimulants are applied to turfgrasses. In various exemplary embodiments, the methods of applying plant biostimulants to crops include applying the plant biostimulants in amounts of from about 0.001 to about 3.0 lbs of nitrogen per 1,000 square feet, more preferably from about 0.05 to about 1.5 lbs. of nitrogen per 1,000 square feet, and even more preferably from about 0.1 to about 1.0 lbs. of nitrogen per 1,000 square feet.

The present invention is further directed to processes of making agricultural products. In various exemplary embodiments, such processes include preparing plant biostimulants by the methods described above, applying the plant biostimulants to crops, and harvesting the crops to obtain agricultural products. Exemplary crops may include food crops and ornamental crops. Exemplary food crops may include fruits, vegetables and grains. Exemplary ornamental crops may include turfgrass, trees, shrubs and flowers. In further exemplary embodiments, such processes may include applying an already prepared plant biostimulant to crops, and harvesting the crops to obtain agricultural products.

Examples of agricultural products include vegetables such as broccoli, cauliflower, globe artichoke, peas, beans, kale, collard greens, spinach, arugula, beet greens, bok choy, chard, choi sum, turnip greens, endive, lettuce, mustard, greens, watercress, garlic chives, gai lan, leeks, Brussels sprouts, capers, kohlrabi, celery, rhubarb, cardoon, Chinese celery, lemon gass, asparagus, bamboo shoots, galangal, ginger, soybean, mung beans, urad, carrots parsnips, beets, radishes, rutabagas, turnips, burdocks, onions, shallots, leeks, garlic, green beans, lentils, and snow peas; fruits, such as tomatoes, cucumbers, squash, zucchinis, pumpkins, melons, peppers, eggplant, tomatillos, christophene, okra, breadfruit, avocado, blackcurrant, redcurrant, gooseberry, guava, lucuma, chili pepper, pomegranate, kiwifruit, grapes, cranberry, blueberry, orange, lemon, lime, grapefruit, blackberry, raspberry, boysenberry, pineapple, fig, mulberry, hedge apple, aplle, rose hip, and strawberry; nuts such as almonds, pecans, walnuts, brazil nuts, cnadlenuts, cahshew nuts, gevuinanuts, horse-chestnuts, macadamia nuts, Malabar chestnuts, mongongo, peanuts, pine nuts, and pistachios; tubers such as potatoes, sweet potatoes, cassava, yams, and dahlias; and cereals or grains such as maize, rice, wheat, barley, sorghum, millet, oats, rye, triticale, fonio, buckwheat, and quinoa.

The present invention is further directed to processes of making consumer products. In various exemplary embodiments, such processes include preparing plant biostimulants by the methods described above, applying the plant biostimulants to crops as described above, harvesting the crops to obtain agricultural products, and processing the agricultural products to obtain consumer products. In further exemplary embodiments, such processes may include applying an already prepared plant biostimulant to crops, harvesting the crops to obtain agricultural products, and processing the agricultural products to obtain consumer products.

Examples of such consumer products include processed foods, such as potato chips, corn chips, jams, jellies, breakfast cereals, breads, etc. The ability to process agricultural products into such consumer products is well within the skill of those skilled in the art.

The present invention is further directed to processes of making industrial products. In various exemplary embodiments, such processes include preparing plant biostimulants by the methods described above, applying the plant biostimulants to crops as described above, harvesting the crops to obtain agricultural products, and processing the agricultural products to obtain industrial products. In further exemplary embodiments, such processes may include applying an already prepared plant biostimulant to crops, harvesting the crops to obtain agricultural products, and processing the agricultural products to obtain industrial products.

The present invention also provides processes of making an animal product, comprising:

applying the plant biostimulant of the present invention to a crop;

harvesting the crop to obtain an agricultural product;

processing said agricultural product to an animal feed;

raising livestock by feeding livestock said animal feed; and

harvesting an animal product from said livestock.

Examples of such animal products include milk, meat, and skin. The ability to harvest such products is well within the skill of those of ordinary skill in the art.

The present invention also provides processes of making an industrial product, comprising:

applying the plant biostimulant of the present invention to a crop;

harvesting the crop to obtain an agricultural product;

processing said agricultural product to an animal feed;

raising livestock by feeding livestock said animal feed;

harvesting an animal product from said livestock; and

processing said animal product to obtain said industrial product.

Examples of such industrial products include cheese, yoghurt, ice cream, and leather. The ability to process animal products into such industrial products is well within the skill of those of ordinary skill in the art.

Other features of the invention will become apparent in the course of the following descriptions of exemplary embodiments which are given for illustration of the invention and are not intended to be limiting thereof.

### EXAMPLES

### Example 1

A bacterial cell cream from an industrial fermentation process for producing lysine was isolated by membrane filtration. The cell cream had a total solids content of approximately 8% by weight, and a total nitrogen content of about 0.8% by weight. Sulfuric acid was added to approximately 300 ml of the cell cream to adjust the pH of the cell cream to 3.5. Hydrolysis was carried out by charging the pH-adjusted cell cream into a 500 ml Ehrlenmeyer flask, which was covered with foil, and placed in an autoclave at 128° C. for 24 hours under 16 lbs. of pressure. Following hydrolysis, the viscosity of the cell cream (hydrolysate) was greatly reduced and there was a clear separation of solubles and insolubles. After cooling, the hydrolysate was filtered through a 20 micron paper filter and the soluble fraction was collected for further analysis. The soluble fraction had a total solids content of approximately 5.6% by weight, and a total nitrogen content of about 0.5% by weight.

The soluble fraction was tested for its ability to elicit a phyto-hormone response in turfgrass by measuring shoot density change over time in comparison with control treatments. During a 70 day trial, turfgrass plots in a greenhouse were foliarly treated on a bi-weekly basis with either water, ammonium sulfate or the soluble fraction in an amount of 0.05 lbs. nitrogen per 1,000 square feet (except for the water control). Turf shoot densities were measured on day 0, day 44, and day 70. The turfgrass treated with the soluble fraction showed a statistically significant (p<0.05) increase in shoot density from day 0 to day 70 in comparison with the control treatments.

### Example 2

### Effect of Industrial Microbial Cell Mass and Hydrolysates Upon the Growth of Radishes

A trial was designed to measure the effect of different fertilizer treatments upon the growth and yield of red radishes (Raphanus sativus) variety Champion. Seeds were germinated in a misting bed and transplanted into 6 inch diameter pots containing peat moss, perlite and vermiculite in a 20:5:5 ratio, respectively. Pots were watered with 200 ml on every Monday, Wednesday and Friday. No fertilizer was provided during the germination period. Treatment fertilizers were applied the same day as transplanting. Treatments are outlined in Table 1. The high rate of nitrogen, 110 kg./ha (98 lbs./ac), is expected to meet requirements of radish production. The low rate of nitrogen, 28 kg/ha (25 lbs/ac) is below the requirement for N. No attempt was made to equalize phosphate or potassium application amounts and neither of these was expected to be deficient in any treatment. Each treatment was applied to four replicates in a completely randomized block design.

Treatments of hydrolyzed cell cream were prepared with fresh cell cream obtained from lysine production (c.a. 10% total solids) by pH adjusting to 7 or 9 with 30% potassium hydroxide before adding papain (Liquipanol® T-100, Enzyme Development Corporation, New York, N.Y.) and bacterial protease (Enzeco® Alkaline Protease L660 Enzyme Development Corporation, New York, N.Y.), respectively. Cell creams were hydrolyzed for a total of 24 hours with constant agitation provided by a stirrer and temperature maintained at 60° C. in a water bath. Enzymes were de-natured by autoclaving hydrolysates for 5 minutes at 120° C. The results are shown in Table 2.

TABLE 1
Description of fertilizer treatments.

| | | mg | mg fertil- |
|---|---|---|---|
| Trt # | Treatment | N/pot | izer/pot |
| Control | Control—no added fertilizer | 0 | 0 |
| Control | Control fertilizer 9-3-6^{a} to | 200 | 2,222 |
| 9-3-6 | equal 110 kg N/ac (98 lbs N/acre) | | |
| Ammonium | Ammonium sulfate (Certified ACS) | 200 | 952 |
| Sulfate | equal to 110 kg N/ac (98 lbs N/acre) | | |
| DBC | DBC (toll granulated) to equal 110 kg | 200 | 2,000 |
| | N/ac (98 lbs N/acre) | | |
| Protease | Hydrolyzed Cell Cream by bacterial | 200 | 16,0000 |
| High | protease to equal 110 kg N/ac | | |
| | (98 lbs N/acre) | | |
| Protease | Hydrolyzed Cell Cream by bacterial | 50 | 4,000 mg |
| Low | protease to equal 28 kg N/ha | | |
| | (25 lbs N/acre) | | |
| Papain | Hydrolyzed Cell Cream by papain to | 200 | 16,000 mg |
| High | equal 110 kg N/ac (98 lbs N/acre) | | |
| Papain | Hydrolyzed Cell Cream by papain to | 50 | 4,000 mg |
| Low | equal 28 kg N/ha (25 lbs N/acre) | | |

^{a}Control fertilizer 9-3-6: from Dyna Gro, San Pablo, CA; derived from: ammonium nitrate, calcium nitrate, potassium nitrate, ammonium phosphate, potassium phosphate, cobaltous sulfate, magnesium sulfate, molybdic acid, iron disodium ethylenedinamine tetra acetate.

TABLE 2
Radish weight and nitrogen use efficiency.

| | Treatment | | | | | | | | |
|---|---|---|---|---|---|---|---|---|---|
| | Control no | Control | Ammonium | | Protease | Papain | Protease | Papain | |
| Item | Fertilizer | 9-3-6 | Sulfate | DBC | High | High | Low | Low | SEM |
| Radish wt., gm | 11.23^{a} | 16.49^{ab} | 18.63^{ab} | 19.78^{b} | 16.44^{ab} | 16.29^{a} | 19.78^{b} | 19.22^{ab} | 3.00 |
| Leaf wt., gm | 5.26^{a} | 8.77^{b} | 8.89^{b} | 9.51^{b} | 8.64^{b} | 9.76^{b} | 8.74^{b} | 8.43^{ab} | 1.23 |
| Total growth., gm | 16.49^{a} | 25.26^{ab} | 27.53^{b} | 29.29^{b} | 25.08^{ab} | 26.05^{ab} | 28.53^{ab} | 27.65^{ab} | 3.80 |
| Nitrogen efficiency, | NA | 26.31^{a} | 37.02^{a} | 42.74^{a} | 26.07^{a} | 25.30^{a} | 171.08^{b} | 159.70^{b} | 2.31 |
| g radish/mg N | | | | | | | | | |

^{ab}Means with unlike superscripts within a row differ P < 0.05.

### Results.

All fertilizer treatments numerically increased radish weight compared with no fertilizer (see Table 2), indicating a positive response to nitrogen. Ammonium sulfate and Control 9-3-6 produced statistically similar radish weights. This suggests that there was no unmet requirement for phosphorous or potassium due to a lack of response. Three treatments, DBC, Protease Low and Papain Low produced statistically greater radish yield compared with Control. Surprisingly, the hydrolyzed treatments, Protease and Papain, produced numerically lower yields when applied in isonitrogenous amounts compared with DBC, even though these are essentially the same materials. There was an apparent inverse correlation between level of hydrolyzed treatment fertilizer applied and yield of radish. High nitrogen application can stunt radish root formation, but other high nitrogen treatments were not as low in yield which suggests nitrogen was not too high. In addition, the treatments Protease Low and Papain Low provided only 25% the nitrogen amount compared with all others and produced similar yields to the highest producer, DBC. These results, a similar yield of radish with 25% as much nitrogen coupled with an apparent reduction in yield when over-applied suggest that the hydrolyzed treatments, Protease and Papain, have biostimulant affects upon radish root yield. Leaf growth was statistically increased by Ammonium Sulfate and DBC compared with Control, while all others were numerically higher. As a result of high yields with less nitrogen, the efficiency of nitrogen use for radish production was statistically higher in Protease Low and Papain Low compared with all others. This trial is not designed to accurately measure nitrogen efficiency use as most of the treatments are applied at only one level; however, the large difference between the low hydrolysate treatments and all others is unexpected and indicates a biostimulant effect.

### Conclusions.

Fertilizer applications increased radish yield and DBC, Protease Low and Papain Low produced radish weights significantly higher compared with Control. Higher application rates of hydrolysates tended to lower radish weight. The lowest application rate of hydrolysates provided only one fourth as much nitrogen as DBC but produced similar yields, suggesting some biostimulant effect. Hydrolyzed cell cream has potential to increase root crop production with lower nutrient inputs.

### Example 3

### The Effect of DBC or Hydrolyzed Cell Cream Upon the Root Growth of Seeded Creeping Bentgrass

All treatments except the negative control received a base fertilizer (9-4-6) as needed to make all treatments iso-nitrogenous. Treatments were applied in replicates of five. The treatments are shown below:

| | | |
|---|---|---|
| 1 | Control—no added fertilizer | |
| 2 | Ammonium sulfate equal to 0.1 lb N/1,000 ft2; | 0.45 mg N/tube |
| 3 | DBC equal to 0.10 lbN/1,000 ft2 | 0.45 mg N/tube |
| 4 | DBC equal to 1.0 lb N/1,000 ft2 | 4.50 mg N/tube |
| 5 | Protease hydrolyzate equal to 0.10 lb N/1,000 ft2 | 0.45 mg N/tube |
| 6 | Protease hydrolyzate equal to 1.0 lbs N/1,000 ft2 | 4.5 mg N/tube |
| 7 | Papain hydrolyzate equal to 0.10 lbsN/1,000 ft2 | 0.45 mg N/tube |
| 8 | Papain hydrolyzate equal to 1.0 lbs N/1,000 ft2 | 4.5 mg N/tube |

Growth tubes were filled with starter planting media (90% sand 10% peat, volume basis) and seeded with creeping bentgrass. Treatments were applied at time of seeding. Root growth was measured 7 days after germination and every 7 days thereafter. Tubes were kept under a mister system to supply adequate water. After 40 days the tubes will cut open and the root mass measured. The results are shown in Table 3.

TABLE 3
Effect of treatment upon root growth of turfgrass.

| | Treatment, n = 5 | | | | | | | |
|---|---|---|---|---|---|---|---|---|
| Item | 1 | 2 | 3 | 4 | 5 | 6 | 7 | 8 |
| Root | 30.23 | 29.08 | 36.83 | 29.08 | 30.99 | 29.97 | 30.10 | 31.75 |
| length, cm | | | | | | | | |
| Root | 114 | 66 | 87 | 79 | 68 | 90 | 90 | 83 |
| weight, g | | | | | | | | |

### Results.

Root mass (grams) was lower in all fertilizer treatments compared with Control no fertilizer. This may be due to increased top growth and decreased root growth when nutrients are readily available such as in the fertilized groups. Ideally, nitrogen fertilizer will support top growth and turf quality and good root growth. The treatments 3-7, which contained bacterial cells, provided nitrogen and supported growth of more root mass compared with the positive control Ammonium Sulfate. In addition, the hydrolyzed bacterial treatments 6 and 7 resulted in the two highest root mass. Length of root was not affected by treatment except treatment 3 was longer compared all others.

### Conclusions.

Dried bacterial cells treated turf had the greater root length and mass compared with the positive control. Hydrolyzed bacterial cells treated turf had the greatest root mass among all treatments that received nitrogen.

### Example 4

### Effect of Hydrolyzed Cell Mass Upon Growth of Broccoli Plants and Leaf Chlorophyll Content

Broccoli plants were randomly assigned to one of three treatments in replicates of seven. Treatments included Control, no added fertilizer, Conventional fertilizer, and Hydrolyzed cell mass. The treatments were applied to the soil to equal 38 mg nitrogen per plant during week 2 and week 4 four of the trial. The trial period lasted 42 days. Broccoli plants were weighed on day 42 of the trial. On day 42 of the trial a chlorophyll reading of leaf tissue was obtained using the Minolta chlorophyll meter (model SPAD 502). The results are shown in Table 4.

TABLE 4
Effect of treatment upon broccoli weight and leaf chlorophyll.

| | | | | Contrasts: probability | | |
|---|---|---|---|---|---|---|
| | | | | value n = 7 | | |
| | Treatment | | | Cont. | Cont. | Conv. |
| | Con- | Conven- | Hydro- | vs. | vs. | Vs. |
| | trol | tional | lyzed | Conv. | Hydro. | Hydro. |
| Plant | 5.8 | 17.0 | 13.0 | 0.000 | 0.000 | 0.000 |
| weight, g | | | | | | |
| Chloro- | 47.8 | 53.5 | 58.1 | 0.003 | 0.000 | 0.012 |
| phyll | | | | | | |
| value | | | | | | |

### Results.

Fertilizer application increased growth and chlorophyll content of broccoli plants, regardless of treatment. Hydrolyzed cell mass statistically reduced growth of broccoli plants while also statistically increased chlorophyll content of the leaf. These data suggest Hydrolyzed cell mass have a biostimulant effect on broccoli plant growth. Plant growth regulators, or plant hormones, affect growth in a dose dependent manner. For example a small amount of auxin promotes faster growth, whereas larger amounts can be deleterious. Hydrolyzed cell mass affected growth of broccoli plant by reducing it when applied at the dose used in this trial. Nitrogen availability was adequate for pant growth in Hydrolyzed plants as indicated by a statistically higher chlorophyll content in these plants.

Reduction of above soil plant growth can be economically beneficial in nursery applications or commercial seedling production operations. In these examples, growers need a healthy, green plant with good chlorophyll concentrations but they don't want too fast growth so that the plants outgrow their containers or become stemmy while at the retail outlet.

### Example 5

### Effect of Hydrolyzed Cell Mass Upon Growth of Sweet Pepper Plants and Leaf Chlorophyll Content

Sweet pepper plants were randomly assigned to one of three treatments in replicates of eight. Treatments included Control, no added fertilizer, Conventional fertilizer, and Hydrolyzed cell mass. The treatments were applied to the soil to equal 38 mg nitrogen per plant during week 2 and week 4 four of the trial. The trial period lasted 42 days. Broccoli plants were weighed on day 42 of the trial. On day 42 of the trial a chlorophyll reading of leaf tissue was obtained using the Minolta chlorophyll meter (model SPAD 502). The results are shown in Table 5.

TABLE 5
Effect of treatment upon sweet pepper weight and leaf chlorophyll.

| | | | | Contrasts: probability | | |
|---|---|---|---|---|---|---|
| | | | | value n = 8 | | |
| | Treatment | | | Cont. | Cont. | Conv. |
| | Con- | Conven- | Hydro- | vs. | vs. | Vs. |
| | trol | tional | lyzed | Conv. | Hydro. | Hydro. |
| Plant | 4.1 | 12.7 | 9.6 | 0.000 | 0.000 | 0.018 |
| weight, g | | | | | | |
| Chloro- | 39.4 | 46.8 | 49.6 | 0.000 | 0.000 | 0.211 |
| phyll | | | | | | |
| value | | | | | | |

### Results.

Fertilizer application increased growth and chlorophyll content of sweet pepper plants, regardless of treatment. Hydrolyzed cell mass statistically reduced plant weight of sweet pepper plants compared with Conventional fertilizer. However, nitrogen was not deficient in these plants as evidenced by a numerically higher chlorophyll content compared with Conventional plants. These data suggest Hydrolyzed cell mass has a biostimulant effect on sweet pepper plant growth. Hydrolyzed cell mass provides adequate nutrition for plant health, indicated by high chlorophyll result, but is able to control growth rate of above ground plant.

Reduction of above soil plant growth can be economically beneficial in nursery applications or commercial seedling production operations. In these examples, growers need a healthy, green plant with good chlorophyll concentrations but they don't want too fast growth so that the plants outgrow their containers or become stemmy while at the retail outlet.

### Example 6

### Effect of Hydrolyzed Cell Mass Upon Growth of Tomato Plants and Leaf Chlorophyll Content

Tomato plants were randomly assigned to one of three treatments in replicates of ten. Treatments included Control, no added fertilizer, Conventional fertilizer, and Hydrolyzed cell mass. The treatments were applied to the soil to equal 30 mg nitrogen per plant during week 2 and week 4 four of the trial. The trial period lasted 42 days. Tomato plants were weighed on day 42 of the trial. On day 42 of the trial a chlorophyll reading of leaf tissue was obtained using the Minolta chlorophyll meter (model SPAD 502). The results are shown in Table 6.

TABLE 6
Effect of treatment upon tomato weight and leaf chlorophyll.

| | | | | Contrasts: probability | | |
|---|---|---|---|---|---|---|
| | | | | value n = 10 | | |
| | Treatment | | | Cont. | Cont. | Conv. |
| | Con- | Conven- | Hydro- | vs. | vs. | Vs. |
| | trol | tional | lyzed | Conv. | Hydro. | Hydro. |
| Plant | 9.4 | 16.4 | 14.6 | 0.000 | 0.000 | 0.001 |
| weight, g | | | | | | |
| Chloro- | 35.1 | 46.9 | 46.3 | 0.000 | 0.000 | 0.597 |
| phyll | | | | | | |
| value | | | | | | |

### Results.

Fertilizer application increased growth and chlorophyll content of tomato plants, regardless of treatment. Hydrolyzed cell mass statistically reduced growth of tomato plants but did not affect chlorophyll content of the leaf. These data suggest Hydrolyzed cell mass have a biostimulant effect on tomato plant growth. Plant growth regulators, or plant hormones, affect growth in a dose dependent manner. For example a small amount of auxin promotes faster growth, whereas larger amounts can be deleterious. Hydrolyzed cell mass affected growth of tomato plant by reducing it when applied at the dose used in this trial.

Where a numerical limit or range is stated herein, the endpoints are included. Also, all values and subranges within a numerical limit or range are specifically included as if explicitly written out.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A method of producing a plant biostimulant, comprising:
hydrolyzing bacterial cells to obtain a hydrolysate; and
formulating the hydrolysate as the plant biostimulant for foliar application or application as a soil adjuvant.

2. A method according to claim 1, wherein said hydrolyzing bacterial cells comprises hydrolyzing a cell cream having a solids content of from about 1 to about 30 weight percent.

3. A method according to claim 1, wherein said hydrolyzing bacterial cells comprises hydrolyzing a cell cream having a nitrogen content of from about 0.12 to about 4 weight percent.

4. A method according to claim 1, wherein said hydrolyzing bacterial cells comprises hydrolyzing with at least one enzyme that is capable of hydrolyzing bacterial proteins into at least one of free amino acids and short peptides.

5. A method according to claim 1, wherein said hydrolyzing bacterial cells comprises performing acid hydrolysis.

6. A method according to claim 1, wherein said hydrolyzing bacterial cells comprises performing alkali hydrolysis.

7. A method according to claim 1, wherein said formulating said hydrolysate comprises formulating for foliar application.

8. A method according to claim 1, wherein said formulating said hydrolysate comprises formulating for application as a soil adjuvant.

9. A method according to claim 1, wherein said formulating said hydrolysate comprises formulating without chelating said hydrolysate and without separating amino acids from the hydrolysate.

10. A method according to claim 1, wherein said formulating said hydrolysate comprises collecting both liquid and solid fractions of said hydrolysate.

11. A method according to claim 1, wherein said formulating said hydrolysate comprises collecting separating liquid and solid fractions of said hydrolysate and retaining the liquid fraction as the plant biostimulant.

12. A method according to claim 1, wherein said formulating said hydrolysate comprises collecting separating liquid and solid fractions of said hydrolysate and retaining the solid fraction as the plant biostimulant.

13. A method according to claim 1, wherein said plant biostimulant has a total nitrogen content of from 5 to 15 wt % on a dry matter basis.

14. A method according to claim 1, wherein said plant biostimulant has a total solids content of 2 to 100 wt %.

15. A method according to claim 1, wherein said plant biostimulant has a pH of 2 to 10.

16. A plant biostimulant obtained by a process according to claim 1.

17. A process for treating a crop, comprising applying a plant biostimulant according to claim 16 to a crop.

18. A process according to claim 17, wherein said plant biostimulant is applied in an amount of from about 0.001 to about 3.0 lbs. of nitrogen per 1,000 square feet.

19. A process of making an agricultural product, comprising:
applying a plant biostimulant according to claim 16 to a crop; and
harvesting the crop to obtain an agricultural product.

20. A process according to claim 19, wherein said agricultural product is selected from the group consisting of a vegetable, a fruit, a tuber, a nut, and a grain.

21. A process of making a consumer product, comprising:
applying a plant biostimulant according to claim 16 to a crop;
harvesting the crop to obtain an agricultural product; and
processing the agricultural product to obtain the consumer product.

22. A process according to claim 21, wherein said consumer product is selected from the group consisting of potato chips, corn chips, jams, jellies, breakfast cereals, breads, cookies, cakes, crackers, flour, and animal feed.

23. A process of raising livestock, comprising feed livestock with animal feed which is prepared by a process according to claim 22.

24. A process according to claim 23, wherein said livestock is selected from the group consisting of a pig, a horse, a cattle, a sheep, a goat, and a rabbit.

25. A process of making an animal product, comprising:
applying the plant biostimulant of claim 16 to a crop;
harvesting the crop to obtain an agricultural product;
processing said agricultural product to an animal feed;
raising livestock by feeding livestock said animal feed; and
harvesting an animal product from said livestock.

26. A process according to claim 25, wherein said animal product is selected from the group consisting of milk, meat, and skin.

27. A process of making an industrial product, comprising:
applying the plant biostimulant of claim 16 to a crop;
harvesting the crop to obtain an agricultural product;
processing said agricultural product to an animal feed;
raising livestock by feeding livestock said animal feed;
harvesting an animal product from said livestock; and
processing said animal product to obtain said industrial product.

28. A process according to claim 27, wherein said industrial product is selected from the group consisting of cheese, yoghurt, ice cream, and leather.
